(19) United States
(12) Patent Application Publication
(10) Pub. No.: US 2018/0149497 A1
(43) Pub. Date: May 31, 2018

(54) SCROLL WHEEL DECODER WITH TWO SENSORS FOR DETERMINING ROTATION AMOUNT AND ROTATION DIRECTION OF SCROLL WHEEL RESPECTIVELY

(71) Applicant: Yao-Sheng SHEN, Taipei City, (TW)

(72) Inventor: Yao-Sheng SHEN, Taipei City, (TW)

(21) Appl. No.: 15/399,802

(22) Filed: Jan. 6, 2017

(30) Foreign Application Priority Data
Nov. 30, 2016 (TW) 105139466

(51) Int. Cl. G01D 5/347

(52) U.S. Cl. CPC G01D 5/3473

(57) ABSTRACT

A scroll wheel decoder includes two fixing bases, a scroll wheel, a rotary disk, and a rotation speed sensor and a rotation direction sensor for determining the rotation amount and rotation direction of the scroll wheel respectively. The fixing bases are provided on a circuit board in a computer mouse to support the rotating shaft of the scroll wheel, for enabling the rotary disk to rotate along with the scroll wheel. The rotary disk has peripheral teeth. The rotation speed sensor projects a first detection signal to be blocked by the teeth sequentially so that a control module can calculate the rotation speed and hence rotation amount of the scroll wheel. The rotation direction sensor projects a second detection signal to the scroll wheel, and the control module can identify the rotation direction of the scroll wheel according to the signal reflected by the scroll wheel.

### FIELD OF THE INVENTION

The present invention relates to a scroll wheel decoder that uses two sensors to determine the rotation amount and rotation direction of a scroll wheel respectively. More particularly, the invention relates to a scroll wheel decoder provided in a computer mouse and having a rotation direction sensor and a rotation speed sensor, wherein the rotation direction sensor corresponds in position to a scroll wheel and the rotation speed sensor, to a rotary disk on the scroll wheel so that the rotation direction of the scroll wheel, the rotation speed of the rotary disk, and consequently the rotation amount of the scroll wheel can be derived from signals respectively detected by the sensors.

### BACKGROUND OF THE INVENTION

Computer mice are essential peripherals for operating computers. Basically, the structure of a computer mouse (hereinafter also referred to as a mouse for short) includes a sensor (e.g., a traditional sensing mechanism composed of a ball and a rotating shaft, or an optical identification mechanism, which is increasingly popular nowadays) at the bottom and two buttons on the top whereby a user can change the cursor position on a computer screen and input instructions respectively. In addition, a scroll wheel is typically provided in order for the user to perform finer control operations on the computer (e.g., to scroll the image on the screen) intuitively and conveniently by turning the scroll wheel. While the scroll wheel of a mouse seems simple in structure, its design varies from one manufacturer to another. The various structural designs of scroll wheels lead to differences in mouse performance.

Generally, a mouse is provided therein with a scroll wheel decoder for identifying the rotation direction and rotation amount of a scroll wheel and generating corresponding instructions. FIG. 1 shows a conventional scroll wheel decoder 1 that includes two fixing bases 11, a scroll wheel 12, a rotary disk 13, and a sensor 14. The fixing bases 11 are provided on a circuit board 10 in the mouse. The scroll wheel 12 has a rotating shaft 120 provided on the fixing bases 11. The rotary disk 13 is provided on the rotating shaft 120 in order to rotate along with the rotating shaft 120. The periphery of the rotary disk 13 is protrudingly provided with a plurality of teeth 131.

The sensor 14 includes two transmitter units 141 and two receiver units 142. The transmitter units 141 and the receiver units 142 are provided on two opposite sides of the rotary disk 13 respectively. Each transmitter unit 141 corresponds in position to one receiver unit 142. When rotated, the rotary disk 13 blocks the detection signals between a corresponding pair of transmitter unit 141 and receiver unit 142 with one of its teeth 131 to begin with. Then, the very tooth 131 is displaced to a position between the two corresponding pairs of transmitter units 141 and receiver units 142 (i.e., to a position where the tooth 131 does not block any detection signals). After that, the tooth 131 is further displaced to a position between the other corresponding pair of transmitter unit 141 and receiver unit 142. Based on the order in which the two corresponding pairs of transmitter units 141 and receiver units 142 are blocked, a control module 101 on the circuit board 10 can determine the “rotation direction” of the scroll wheel 12. In the meantime, the control module 101 calculates the rotation speed of the rotary disk 13, and consequently the “rotation amount” of the scroll wheel 12, from the interval of the detection signals, in order for the computer to scroll the image on the screen by a certain distance.

The foregoing design, however, leaves something to be desired, given the current market trends of computer products and peripherals toward “compactness”. To reduce the volume of a mouse with the scroll wheel decoder 1 described above, the scroll wheel 12 and the rotary disk 13 must be downsized as much as possible, but this poses challenges to the identification principle of the scroll wheel decoder 1. More specifically, the scroll wheel decoder 1 identifies the rotation direction and rotation amount by the order in which and the frequency at which the teeth 131 pass the two corresponding pairs of transmitter units 141 and receiver units 142. If the rotary disk 13 is made smaller, production errors may result in overly wide teeth 131 that cannot be positioned between the two corresponding pairs of transmitter units 141 and receiver units 142 without blocking both pairs at the same time (i.e., the width of each tooth 131 is greater than the distance between the transmitter units 141/the receiver units 142). Should this occur, the control module 101 will be unable to identify the rotation direction of the rotary disk 13 accurately.

Since the problem described above can only be solved by increasing the precision of the rotary disk 13, a manufacturer trying to prevent errors of the teeth 131 on the rotary disk 13 from compromising mouse performance must choose between “compactness of mice” and “scroll wheel sensitivity”, if unable or unwilling to invest more to ensure that the size of the rotary disk 13 matches the spacing between the transmitter units 141/the receiver units 142 perfectly. In the light of this, the inventor of the present invention wondered if the structural principle of scroll wheel decoders can be further improved to resolve the dilemma. The issue to be addressed by the present invention, therefore, is to design a novel scroll wheel decoder whose accuracy is ensured regardless of production errors of its components.

### BRIEF SUMMARY OF THE INVENTION

In view of the fact that the conventional scroll wheel decoders may be inaccurate due to production errors, the inventor of the present invention put years of practical experience into extensive research, repeated trials, and persistent improvement and finally succeeded in developing a scroll wheel decoder that has two sensors for determining the rotation amount and rotation direction of a scroll wheel respectively, and whose innovative scroll wheel identification method contributes to “mouse compactness” as well as “scroll wheel sensitivity”.

It is an objective of the present invention to provide a scroll wheel decoder that uses two sensors to determine the rotation amount and rotation direction of a scroll wheel respectively. The scroll wheel decoder is applicable to a computer mouse that has a circuit board therein, and the circuit board is provided at least with a control module. The scroll wheel decoder includes two fixing bases, a scroll wheel, a rotary disk, a rotation speed sensor, and a rotation direction sensor. The two fixing bases are provided on the circuit board and are spaced apart by a predetermined distance such that a rotation space is formed between the fixing bases. The scroll wheel is provided with a rotating shaft along its axis. Each of the two ends of the rotating shaft is positioned at a top portion of a corresponding one of the fixing bases to enable free rotation of the scroll wheel within the rotation space. The rotary disk is provided on the rotating shaft and can rotate along with the rotating shaft. The periphery of the rotary disk is protrudingly provided with a plurality of teeth, and each two adjacent ones of the teeth form a notch therebetween. The rotation speed sensor is electrically connected to the control module and includes a transmitter unit and a receiver unit. The transmitter unit and the receiver unit are provided on two opposite sides of the rotary disk respectively. When the rotary disk is rotated, the teeth pass through the space between the transmitter unit and the receiver unit sequentially, and the receiver unit can receive a first detection signal projected by the transmitter unit only through a corresponding one of the notches. Thus, the control module can determine the rotation speed of the scroll wheel according to the interval at which the receiver unit receives a succession of first detection signals and then calculate the amount by which the scroll wheel is actually rotated. The rotation direction sensor is also electrically connected to the control module and is provided adjacent to the scroll wheel in order to project a second detection signal to the scroll wheel. The second detection signal is reflected by the surface of the scroll wheel to generate a rotation direction determination signal. The control module can identify the rotation direction of the scroll wheel according to the rotation direction determination signal received by the rotation direction sensor and then generate a scroll wheel operation signal according to the rotation direction and the rotation amount determined. As the rotation direction sensor does not determine the rotation direction according to “whether detection signals are blocked by the teeth of the rotary disk”, the design drawback of the prior art is effectively overcome.

### BRIEF DESCRIPTION OF THE SEVERAL VIEWS OF THE DRAWINGS

The structural features, mechanism of determination, and objectives of the present invention can be better understood by referring to the following detailed description in conjunction with the accompanying drawings, in which:

FIG. 1 is an exploded perspective view of a conventional scroll wheel decoder;

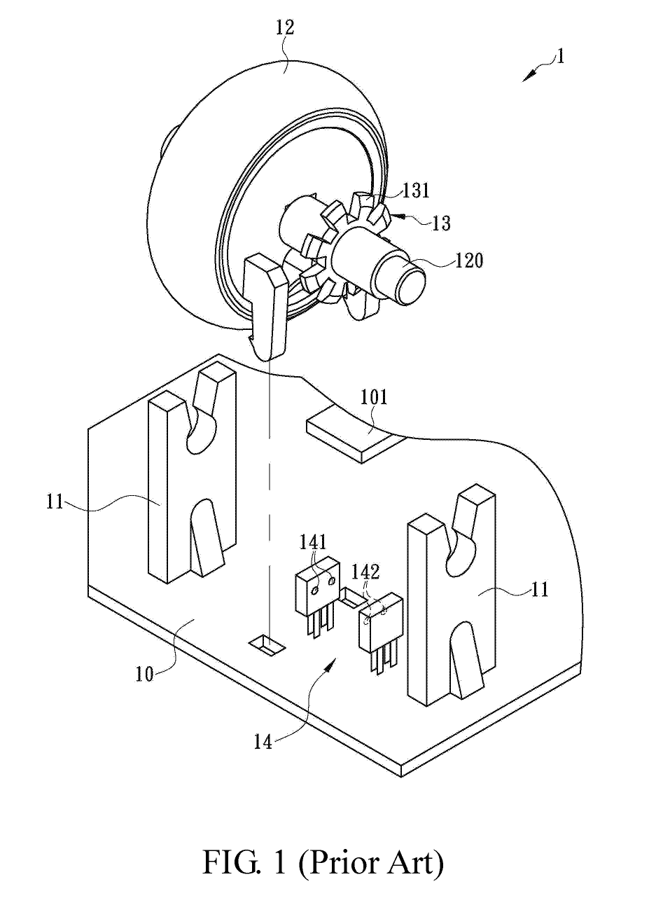

FIG. 2 is an exploded perspective view of a scroll wheel decoder according to the present invention; and

FIG. 3 is an exploded perspective view of a scroll wheel according to the present invention.

### DETAILED DESCRIPTION OF THE INVENTION

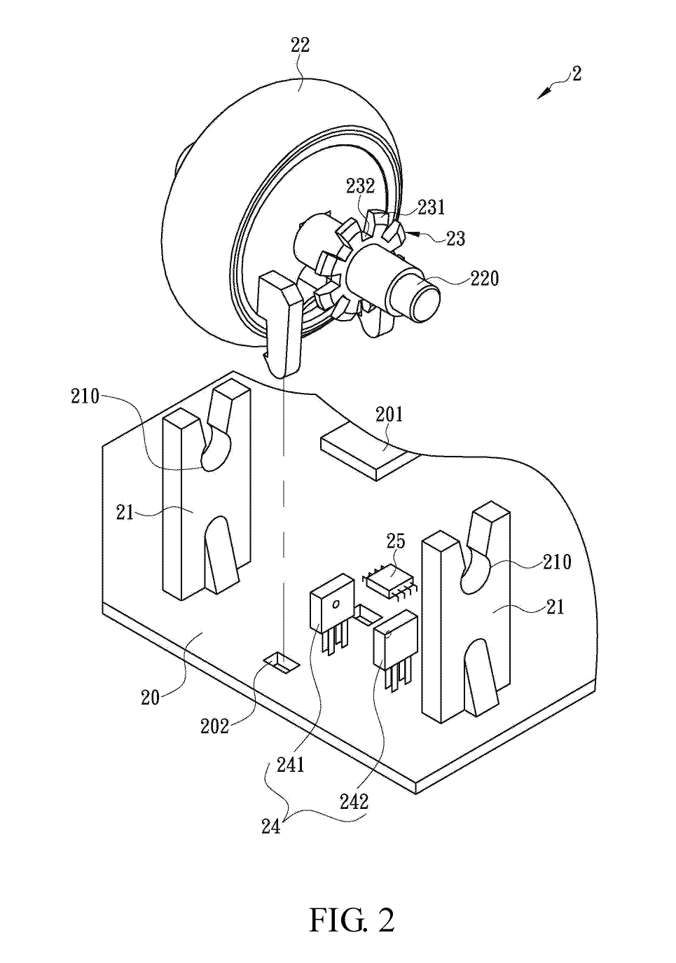

The present invention provides a scroll wheel decoder having two sensors for determining the rotation amount and rotation direction of a scroll wheel respectively. Referring to FIG. 2 for a preferred embodiment of the present invention, the scroll wheel decoder 2 is applied to a computer mouse. The mouse is provided therein with a circuit board 20, and the circuit board 20 is provided at least with a control module 201. The mouse may be a mechanical or optical mouse, and there is no limitation on the number of buttons on the mouse. As the technical point of the present invention consists in the improvement that has been made to the scroll wheel decoder 2, the other components of the mouse will not be detailed herein.

The scroll wheel decoder 2 includes two fixing bases 21, a scroll wheel 22, a rotary disk 23, a rotation speed sensor 24, and a rotation direction sensor 25. The bottom portions of the fixing bases 21 are fixedly provided on the circuit board 20, and the fixing bases 21 are spaced apart by a predetermined distance to form a rotation space therebetween. The scroll wheel 22 is provided with a rotating shaft 220 along its axis. The two ends of the rotating shaft 220 are positioned at the top portions of the fixing bases 21 respectively (e.g., each end pivotally provided in a pivotal connection hole 210 of the corresponding fixing base 21) so that the scroll wheel 22 can rotate freely in the rotation space.

The rotary disk 23 is provided on the rotating shaft 220 and can rotate along with the rotating shaft 220. The periphery of the rotary disk 23 is protrudingly provided with a plurality of teeth 231, and each two adjacent teeth 231 form a notch 232 therebetween such that the rotary disk 23 is in the shape of a toothed-wheel. The rotary disk 23 is spaced apart from the scroll wheel 22 and each fixing base 21.

In the present invention, the rotation speed sensor 24 and the rotation direction sensor 25 are provided to enable the control module 201 to calculate the rotation amount (based on the rotation speed of the rotary disk 23) and rotation direction of the scroll wheel 22. A detailed description of the structures and operations of the sensors is given below. The rotation speed sensor 24 is provided on the circuit board 20, is electrically connected to the control module 201, and works on the same sensing principle as its prior art counterparts, except that only one transmitter unit 241 and one receiver unit 242 are required. The transmitter unit 241 and the receiver unit 242 are provided on two opposite sides of the rotary disk 23 respectively, in order for the teeth 231 to pass through the space between the transmitter unit 241 and the receiver unit 242 sequentially, and for the receiver unit 242 to receive a first detection signal projected by the transmitter unit 241 only through a corresponding one of the notches 232.

The rotation direction sensor 25 is also provided on the circuit board 20 and electrically connected to the control module 201, but the target to be sensed is not the “rotary disk 23” but the “scroll wheel 22” itself. The rotation direction sensor 25 is provided adjacent to the scroll wheel 22 (e.g., adjacent to the bottom side of the scroll wheel 22) so as to project a second detection signal (e.g., an optical detection signal) to the scroll wheel 22. The second detection signal will be reflected by the surface of the scroll wheel 22 to generate a rotation direction determination signal.

The control module 201 is configured to receive the first detection signal from the rotation speed sensor 24 and the rotation direction determination signal from the rotation direction sensor 25, determine the rotation speed of the rotary disk 23 according to the “interval” of a series of first detection signals received by the receiver unit 242, and then calculate the “amount” by which the scroll wheel 22 is actually rotated. The control module 201 is also configured to identify the rotation direction of the scroll wheel 22 according to the rotation direction determination signal received by the rotation direction sensor 25. Once the rotation direction and the rotation amount are determined, the control module 201 generates a scroll wheel operation signal and sends the signal to a corresponding electronic device (e.g., a personal computer), in order for the electronic device to perform a corresponding action (e.g., to scroll the image on a computer screen by a certain distance).

According to the above, the scroll wheel decoder 2 does not rely on the teeth 231 on the rotary disk 23 to determine the rotation direction as is typical in the prior art, in which the rotation direction is determined according to the order in which a tooth passes a plurality of corresponding pairs of transmitter units and receiver units. Instead, the scroll wheel decoder 2 identifies the rotation direction of the scroll wheel 22 directly through the rotation direction sensor 25, so the aforementioned drawback of the prior art (i.e., production errors of the rotary disk may compromise mouse sensitivity) is effectively overcome. Furthermore, as there is plenty of room between the fixing bases 21 in the first place to allow free rotation of the scroll wheel 22, the rotation direction sensor 25 does not add much to the overall volume of the mouse. Thus, the present invention allows a computer mouse manufacturer to produce mice that feature both “compactness” and “scroll wheel sensitivity”.

In this embodiment, the rotation direction sensor 25 is an optical sensor (e.g. but not limited to a sensor for use in an optical mouse), which is an assembly of a micro camera and a light-emitting element and is configured to capture images of the surface of the scroll wheel 22 so that the control module 201 can determine the rotation direction of the scroll wheel 22 according to changes in the images captured. Generally, an optical sensor can be used to sense changes in position in two directions (e.g., a horizontal direction and a vertical direction, or the X- and Y-axis directions in a plane), but in the present invention, the control module 201 only has to determine changes in a single direction (because the scroll wheel 22 can only rotate forward or backward).

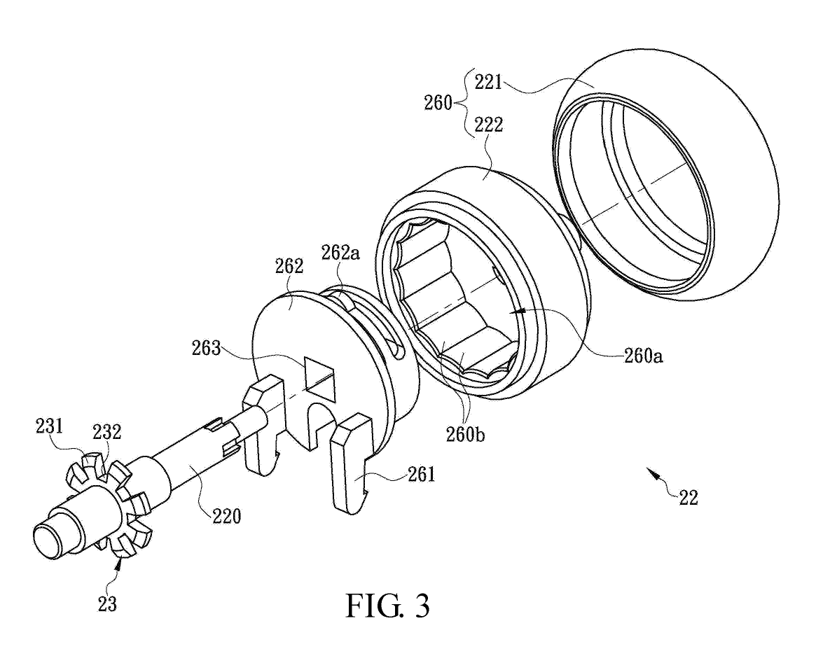

In this embodiment, referring to FIG. 2 and FIG. 3, the scroll wheel 22 further includes a rim 260, at least one stand 261, and a pivotal connection disk 262. The rim 260 includes an outer rim portion 221 and an inner rim portion 222 mounted in the outer rim portion 221. The rim portions 221 and 222 are made of different materials respectively. One side of the inner rim portion 222 is concavely provided with a pivotal connection groove 260a. The pivotal connection groove 260a has an inner wall circumferentially provided with a plurality of curved portions 260b. Each stand 261 has a bottom portion fixedly provided on the circuit board 20 (e.g., engaged in an assembly hole 202 in the circuit board 20). The pivotal connection disk 262 is provided at top portions of the stands 260 and has a top portion provided with an elastic arm 262a. The elastic arm 262a is movably engaged with the inner wall of the pivotal connection groove 260a, is positioned between two adjacent ones of the curved portions 260b, and allows the rim 260 to rotate with respect to the pivotal connection disk 262.

The pivotal connection disk 262 is provided with a through hole 263. The diameter of the through hole 263 is greater than the diameter of a middle section of the rotating shaft 220 so that the middle section of the rotating shaft 220 can pass through the through hole 263 and connect with the opposite side (hereinafter referred to as the second side) of the rim 260. This configuration allows the rotating shaft 220 to rotate along with the rim 260, and the stands 261 and the pivotal connection disk 262 to remain stationary, while the rim 260 is rotated by the user.

As stated above, the present invention uses the rotation direction sensor 25 to detect the rotation direction of the scroll wheel 22 directly. The rotation direction sensor 25, therefore, may be located to face any part of the scroll wheel 22. For instance, the rotation direction sensor 25 may be fixed on the circuit board 20 at a position corresponding to a bottom portion of the scroll wheel 22 in order to project the second detection signal to the outer circumferential wall of the rim 260.

In another embodiment of the present invention, the rotation direction sensor 25 may be fixedly provided on one of the fixing bases 21 at a position facing the scroll wheel 22 in order to project the second detection signal to the second side of the rim 260. By the same token, the rotation direction sensor 25 may project the second detection signal toward the rotating shaft 220 instead to enable determination of the rotation direction of the scroll wheel 22.

While the invention herein disclosed has been described by means of specific embodiments, numerous modifications and variations could be made thereto by those skilled in the art without departing from the scope of the invention set forth in the claims.

What is claimed is:

1. A scroll wheel decoder with two sensors for determining a rotation amount and a rotation direction of a scroll wheel respectively, wherein the scroll wheel decoder is applicable to a computer mouse, the computer mouse is provided therein with a circuit board, and the circuit board is provided at least with a control module, the scroll wheel decoder comprising:
two fixing bases provided on the circuit board and spaced apart by a predetermined distance such that a rotation space is formed between the fixing bases;
the scroll wheel, provided with a rotating shaft along an axis of the scroll wheel, wherein the rotating shaft has two ends each positioned at a top portion of a corresponding one of the fixing bases so that the scroll wheel is freely rotatable in the rotation space;
a rotary disk provided on the rotating shaft and rotatable along with the rotating shaft, wherein the rotary disk has a periphery protrudingly provided with a plurality of teeth, and each two adjacent said teeth form a notch therebetween;
a rotation speed sensor electrically connected to the control module and comprising a transmitter unit and a receiver unit, wherein the transmitter unit and the receiver unit are provided on two opposite sides of the rotary disk respectively so that, when the rotary disk is rotated, the teeth pass through a space between the transmitter unit and the receiver unit sequentially and a first detection signal projected by the transmitter unit is receivable by the receiver unit only through a corresponding one of the notches in order for the control module to determine a rotation speed of the scroll wheel according to an interval between consecutive said first detection signals received by the receiver unit and thereby calculate the rotation amount of the scroll wheel; and
a rotation direction sensor electrically connected to the control module and provided adjacent to the scroll wheel in order to project a second detection signal to the scroll wheel, wherein the second detection signal is reflected by a surface of the scroll wheel to generate a rotation direction determination signal, and the control module identifies the rotation direction of the scroll wheel according to the rotation direction determination signal received by the rotation direction sensor and generates a scroll wheel operation signal according to the rotation direction and the rotation amount determined.

2. The scroll wheel decoder of claim 1, wherein the rotation direction sensor is an optical sensor.

3. The scroll wheel decoder of claim 2, wherein the scroll wheel comprises:
a rim having a first side concavely provided with a pivotal connection groove;
at least one stand having a bottom portion fixedly provided on the circuit board; and
a pivotal connection disk provided at a top portion of the stand and movably engaged with an inner wall of the pivotal connection groove such that the rim is rotatable with respect to the pivotal connection disk, wherein the pivotal connection disk is provided with a through hole, and the rotating shaft has a middle section passing through the through hole and connected with an opposite second side of the rim.

4. The scroll wheel decoder of claim 3, wherein the rotation direction sensor projects the second detection signal to an outer circumferential wall of the rim.

5. The scroll wheel decoder of claim 3, wherein the rotation direction sensor projects the second detection signal to the second side of the rim.

6. The scroll wheel decoder of claim 3, wherein the rotation direction sensor projects the second detection signal to a surface of the rotating shaft.

7. The scroll wheel decoder of claim 3, wherein the inner wall of the pivotal connection groove is circumferentially provided with a plurality of curved portions, and the pivotal connection disk is protrudingly provided with an elastic arm engageable between each two adjacent said curved portions.

8. The scroll wheel decoder of claim 4, wherein the inner wall of the pivotal connection groove is circumferentially provided with a plurality of curved portions, and the pivotal connection disk is protrudingly provided with an elastic arm engageable between each two adjacent said curved portions.

9. The scroll wheel decoder of claim 5, wherein the inner wall of the pivotal connection groove is circumferentially provided with a plurality of curved portions, and the pivotal connection disk is protrudingly provided with an elastic arm engageable between each two adjacent said curved portions.

10. The scroll wheel decoder of claim 6, wherein the inner wall of the pivotal connection groove is circumferentially provided with a plurality of curved portions, and the pivotal connection disk is protrudingly provided with an elastic arm engageable between each two adjacent said curved portions.
